(19) United States
(12) Patent Application Publication
(10) Pub. No.: US 2010/0134233 A1
(43) Pub. Date: Jun. 3, 2010

(54) INDUCTOR AND METHOD FOR MAKING THE SAME

(75) Inventors: Wan-Hsun WANG, Hsinchu County (TW); Ming-Chang Huang, Taoyuan County (TW)

Correspondence Address: LADAS & PARRY, 5670 WILSHIRE BOULEVARD, SUITE 2100, LOS ANGELES, CA, 90036-5679, US

(73) Assignee: Shih-Jen WANG, Hsinchu County (TW)

(21) Appl. No.: 12/625,501

(22) Filed: Nov. 24, 2009

(30) Foreign Application Priority Data
Nov. 28, 2008 (TW) 097146290
Aug. 13, 2009 (TW) 098127262

(51) Int. Cl. H01F 27/29; H01F 41/00

(52) U.S. Cl. 336/192; 29/606

(57) ABSTRACT

An inductor includes: an inductive coil having a coil portion and two extension legs; a magnetic pillar including a pillar portion that is inserted into the coil portion and that has an upper end projecting upwardly from the inductive coil, and a flange portion radially projecting from the upper end of the pillar portion, the flange portion pressing against an upper end of the coil portion; and an embedding body in which the coil portion and the magnetic pillar are embedded, the extension legs being exposed from the embedding body.

### CROSS-REFERENCE TO RELATED APPLICATION

This application claims priority of Taiwanese application no. 097146290, filed on Nov. 28, 2008, and priority of Taiwanese application no. 098127262, filed on Aug. 13, 2009, both of which are incorporated herein by reference.

### BACKGROUND OF THE INVENTION

1. Field of the Invention

This invention relates to an inductor and a method for making the same, more particularly to an inductor manufactured via a molding process and a method for making the same.

2. Description of the Related Art

As shown in FIG. 1, a conventional inductor 2 disclosed in US 2006/0186975 A1 includes an inductive coil 21 having a coil portion and two opposite ends, a magnetic pillar 22 inserted into the inductive coil 21, and an embedding body 23 in which the coil portion of the coil 21 and the pillar 22 are embedded. In manufacturing the inductor 2, the coil 21 is first positioned in a mold (not shown). Then, the pillar 22 is inserted into the coil 21 until the pillar 22 abuts against a layer of magnetic powder previously charged into the mold to limit the pillar 22 at a certain depth. Thereafter, the pillar 22 is positioned to the coil portion of the coil 21 using a glue dispensing machine (not shown), and an additional amount of magnetic powder is charged to fill the mold. Finally, the magnetic powder is compression molded through powder metallurgy technology to embed the coil 21 and the pillar 22.

As described in US 2006/0186975 A1, the structure of the conventional inductor 2 has an improved inductive quality. However, since the pillar 22 has a uniform cross-section, it is necessary to fill the magnetic powder in the mold by charging the magnetic powder via two charging steps and to use the first charge of the magnetic powder for limiting the depth of the pillar 22 in the mold and for adjusting the position of the pillar 22 relative to the coil 21. Furthermore, the pillar 21 must be positioned to the coil portion of the coil 21 using the glue dispensing machine. Therefore, the method of manufacturing the conventional inductor 2 is complicated. On the other hand, if the method is simplified by charging all of the magnetic powder into the mold at one time, it will be difficult to control the position of the pillar 22, and the depth of the pillar position may be too low or too high.

### SUMMARY OF THE INVENTION

Therefore, one object of the present invention is to provide an inductor that can be manufactured with relative ease. Another object of the present invention is to provide a simplified method for making an inductor.

According to one aspect of the present invention, there is provided an inductor comprising:

an inductive coil having a coil portion and two extension legs;

a magnetic pillar including a pillar portion that is inserted into the coil portion and that has an upper end projecting upwardly from the inductive coil, and a flange portion radially projecting from the upper end of the pillar portion, the flange portion pressing against an upper end of the coil portion; and

an embedding body in which the coil portion and the magnetic pillar are embedded, the extension legs being exposed from the embedding body.

According to another aspect of the present invention, there is provided a method for making an inductor, comprising:

forming a magnetic pillar having an upper end formed with a radially projecting flange;

inserting the magnetic pillar into an inductive coil until the radially projecting flange presses against an upper end of the inductive coil;

disposing the inductive coil together with the magnetic pillar in a mold;

filling the mold with a magnetic powder; and

compression molding the magnetic powder to form an embedding body in which the inductive coil and the magnetic pillar are embedded.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic sectional view of a conventional inductor disclosed in US 2006/0186975 A1;

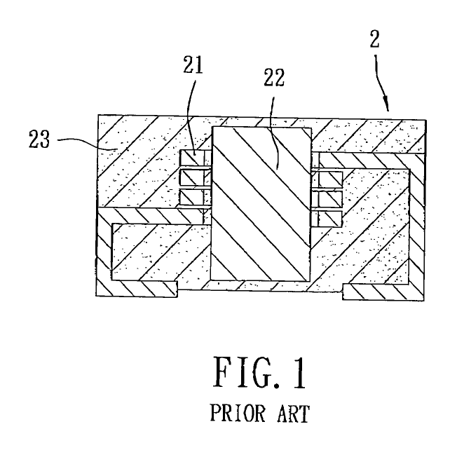

FIG. 2 is a schematic sectional view of an inductor according to the first embodiment of the present invention;

FIG. 3 is a fragmentary schematic sectional view illustrating that a magnetic powder is charged through runners of a mold according to the first embodiment of the present invention;

FIG. 4 is the same view as FIG. 3 but illustrating that the mold is closed;

FIG. 5 is a perspective view of an inductor according to the second embodiment of the present invention;

FIG. 6 is an exploded view illustrating a terminal frame for connection with a plurality of inductive coils according to the second embodiment of the present invention;

FIG. 7 is a fragmentary schematic sectional view illustrating a mold to manufacture the inductor according to the second embodiment of the present invention;

FIG. 8 is the same view as FIG. 7 but illustrating that the mold is closed;

FIG. 9 illustrates terminals are cut off from the terminal frame after compression molding;

FIG. 10 is a perspective view of an inductor according to the third embodiment of the present invention;

FIG. 11 shows a terminal frame for connection with the inductive coil according to the third embodiment of the present invention before compression molding; and

FIG. 12 is the same view as FIG. 11 but illustrating that terminals of the terminal frame are removed from the terminal frame after compression molding.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

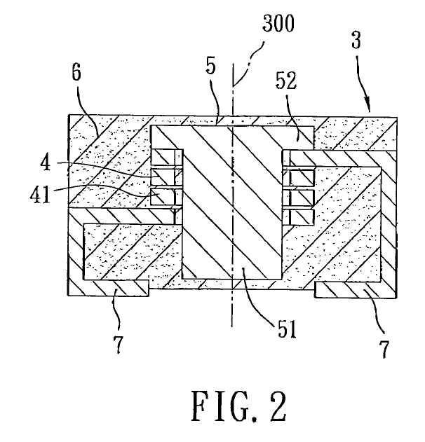

Referring to FIGS. 2 to 4, an inductor of the first embodiment of this invention is shown to include an inductive coil 4, a magnetic pillar 5, and an embedding body 6.

The inductive coil 4 is formed by helically winding a conductive wire along an axis 300 to have a coil portion 41 and two extension legs 7 extending outwardly from the coil portion 41. The extension legs 7 are two ends of the coil portion 41 and are formed as one piece with the coil portion 41. Based on user's requirement, the conductive wire can be flat, circular or square in cross-section. In this embodiment, the conductive wire has a flat cross-section.

The magnetic pillar 5 is made from a magnetic metal rod, and includes a pillar portion 51 and a flange portion 52. The pillar portion 51 is inserted into the coil portion 41 and has an upper end projecting upwardly from the inductive coil 4. The flange portion 52 projects radially from the upper end of the pillar portion 51, and presses against an upper end of the coil portion 41. Accordingly, the magnetic pillar 5 can be directly and accurately positioned to the coil portion 41 of the inductive coil 4.

The embedding body 6 is made of a magnetic metal powder by compression molding, and is used to embed and fix the coil portion 41 of the inductive coil 4 and the magnetic pillar 5. The extension legs 7 are exposed from the embedding body 6 and are substantially flush with an outer surface of the embedding body 6 in this embodiment.

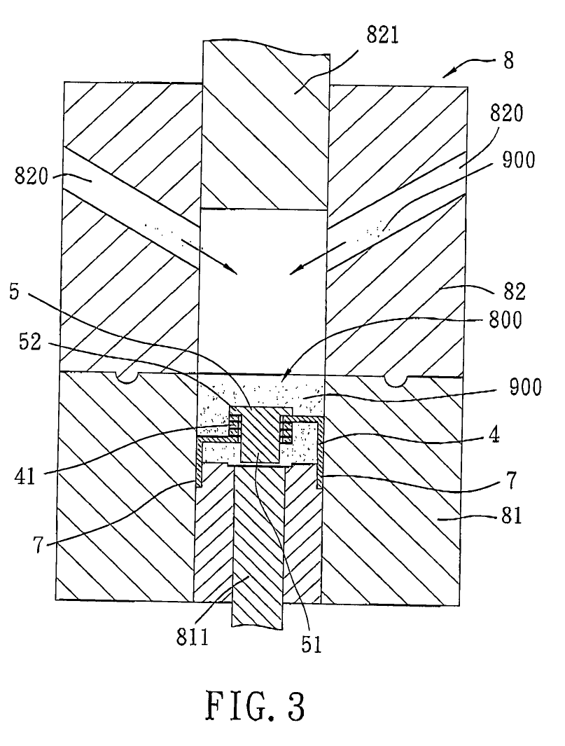

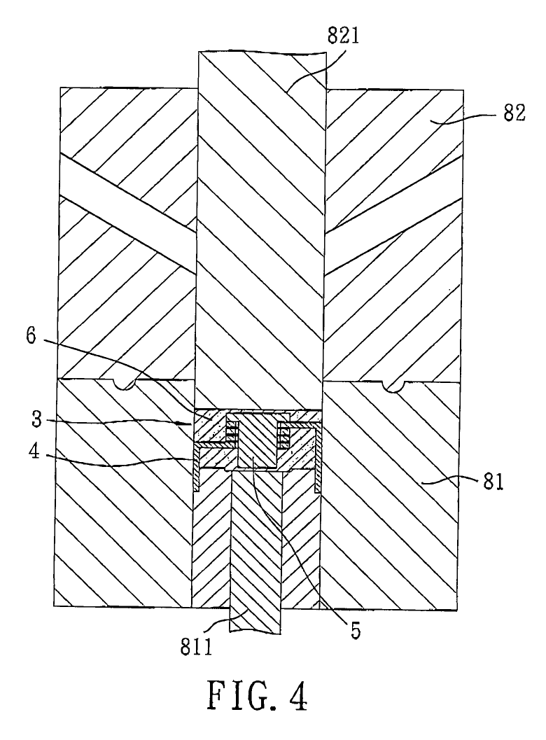

The first embodiment of the method for making the inductor 3 according the present invention will be described hereinafter with reference to FIGS. 3 and 4.

In step (i), the magnetic pillar 5 of the first embodiment is prepared by forming the flange portion 52 on the upper end of the pillar portion 51.

In step (ii), after fixing the extension legs 7 of the inductive coil 4 in a mold cavity 800 of a lower mold part 81 of a mold 8, the pillar 5 is inserted into a central space defined by the coil portion 41 of the inductive coil 4. By abutting the flange portion 52 against the upper end of the coil portion 41, the pillar 5 is positioned directly and accurately at a desired depth in the mold 8. Of course, the pillar 5 can be inserted into the central space of the coil portion 41 before the inductive coil 4 is placed in the lower mold part 81.

In step (iii), as shown in FIG. 3, an upper mold part 82 of the mold 8 is moved downwardly toward the lower mold part 81 to close the mold cavity 800. The magnetic powder 900 is charged through runners 820 of the upper mold part 82 to fill the mold cavity 800 of the mold 8 and to fully cover the coil portion 41 of the inductive coil 4 and the pillar 5.

In step (iv), a plunger 821 of the upper mold part 82 is moved into the mold cavity 800 to compression mold the magnetic powder 900 using powder metallurgy technology, thereby forming the embedding body 6.

In step (v), after separating the upper and lower mold parts 82, 81 from each other, the inductor 3 is removed from the mold cavity 800 of the lower mold part 81 by moving upwardly an ejector 811 of the lower mold part 81.

During compression molding, although the magnetic powder 900 will be forced to move indifferent directions, the magnetic powder 900 above the upper end of the pillar portion 51 and the flange portion 52 can be pressed downward by the plunger 821 to push the flange portion 52 against the coil portion 41 so that the pillar 5 can be firmly fixed in the inductive coil 4. Thus, by the method of the present invention, it is not necessary to use a glue dispensing machine to fix the pillar 5 to the coil portion 41 of the inductive coil 4, and the pillar can be positioned at a more accurate position relative to the inductive coil 4 in the inductor 3.

It should be noted that, in the first embodiment, the magnetic powder 900 is compressed by moving downwardly the plunger 821 of the upper mold part 82. However, for manufacturing an inductor with a larger size, after an upper plunger is moved downward to a certain level to compress downward the magnetic powder 900, the upper plunger may be stopped from moving, and a lower plunger may be used to move upward to compress upward the magnetic powder 900. By compressing the magnetic powder 900 upward and downward, the embedding body 6 can be provided with a highly densified compact structure.

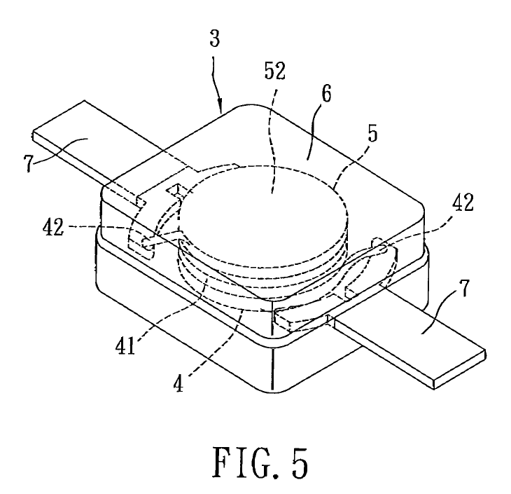

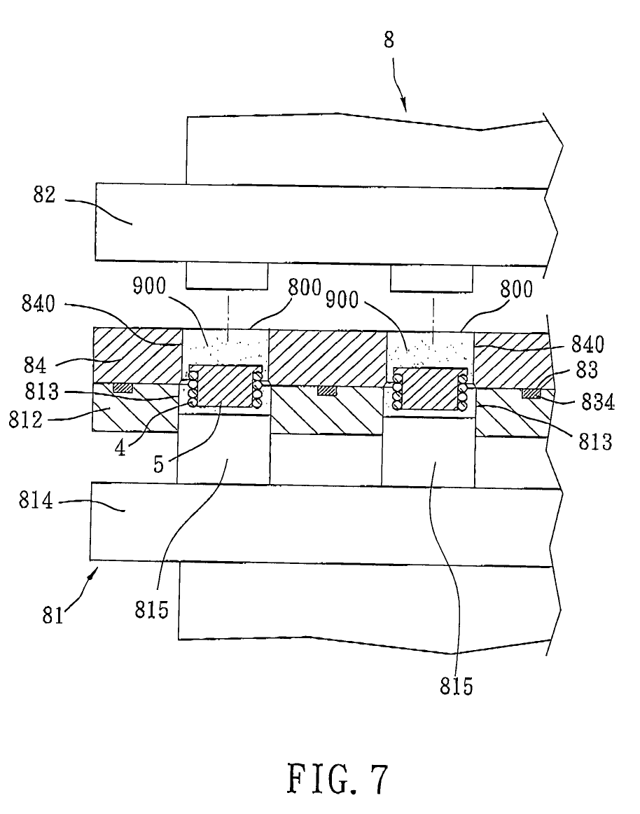

FIG. 5 illustrates the second embodiment of the inductor 3 of this invention. The second embodiment differs from the first embodiment only in the construction of the inductive coil 4. Particularly, the two extension legs 7 project outwardly from the outer surface of the embedding body 6 and are connected respectively to two opposite ends 42 of the coil portion 41 through a soldering process. Furthermore, the conductive wire of the inductive coil 4 has a circular cross-section (see FIG. 7).

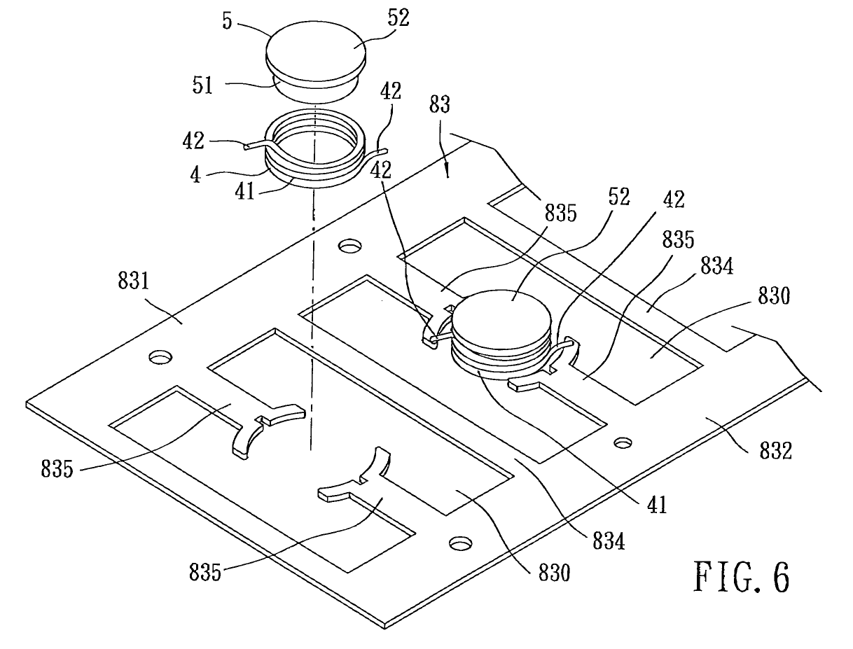

Referring to FIGS. 6 to 9, the second embodiment of the method for making the inductor 3 according the present invention will be described hereinafter.

In step (a), the mold 8 is prepared. The mold 8 of the second embodiment includes a lower mold part 81, an upper mold part 82, and a pressing mold part 84 disposed on the lower mold part 81 and below the upper mold part 82. A terminal frame 83 is disposed in the lower mold part 81 below the pressing mold part 84.

As shown in FIG. 7, the lower mold part 81 includes: a fixed mold plate 812 formed with a plurality of through holes 813; a moving mold portion 814 disposed under the fixed mold plate 812 and movable upward and downward relative to the fixed mold plate 812; and a plurality of plungers 815 formed on the moving mold portion 814 and respectively extending into the through holes 813.

The terminal frame 83 is positioned to the fixed mold plate 812, and, as shown in FIG. 6, includes: parallel first and second rails 831, 832; a plurality of connecting parts 834 interconnecting the first and second rails 831, 832 at intervals; and a plurality of pairs of terminals 835. The space between the first and second rails 831, 832 is divided by the connecting parts 834 into a plurality of sub-spaces 830 which are aligned respectively with the through holes 813 of the fixed mold plate 812. The pairs of the terminals 835 extend respectively into the sub-spaces 830 from the first and second rails 831, 832. The pressing mold part 84 is disposed on the fixed mold plate 812 to fix the terminal frame 83 on the fixed mold plate 812, and is formed with a plurality of through holes 840 that are aligned respectively with the through holes 813 of the fixed mold plate 812. As shown in FIG. 7, the through holes 840 of the pressing mold part 84, the through holes 813 of the fixed mold plate 812, and the plungers 815 cooperatively define a plurality of mold cavities 800, each of which has an upward opening.

In step (b), each of the magnetic pillars 5 is formed with the flange portion 52.

In step (c), a plurality of inductive coils 4 are connected to the terminal frame 83 by soldering the two opposite ends 42 of each of the coil portions 41 to one pair of the terminals 835 such that each of the coil portions 41 is fixed in one of the sub-spaces 830. Then, the pillars 5 are respectively inserted into central spaces defined by the coil portions 41, such that the flange portion 52 of each of the pillars 5 presses against the upper end of the respective coil portion 41. Finally, the terminal frame 83 mounted with the inductive coils 4 and the pillars 5 is installed on the fixed mold plate 812, and the pressing mold part 84 is disposed on the fixed mold plate 812 to fix the terminal frame 83. As a result, each coil portion 41 together with the corresponding pillar 5 is suspended in one of the mold cavities 800 by virtue of the terminal frame 83.

In step (d), the magnetic powder 900 is charged to fill the mold cavities 800 of the mold 8 through the opening of each mold cavity 800.

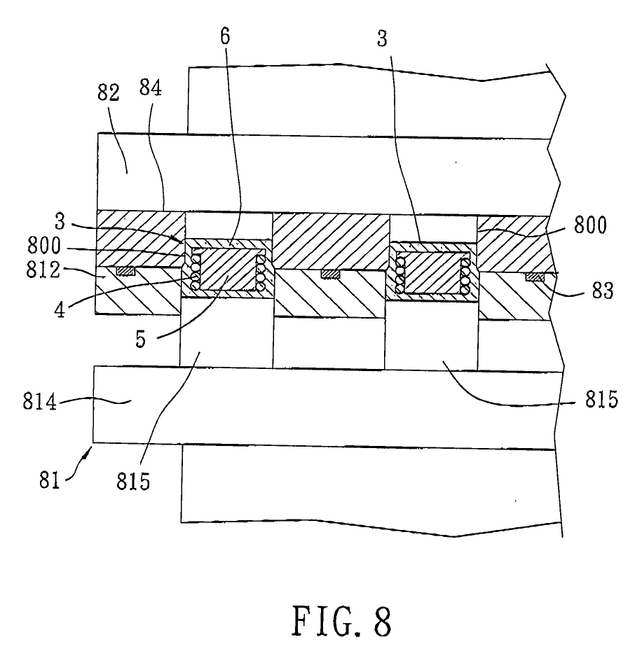

In step (e), the upper mold part 82 is moved toward the lower mold part 81, as shown in FIG. 8, such that the magnetic powder 900 is compression molded to form a plurality of embedding bodies 6.

In step (e) of this embodiment, compression molding of the magnetic powder 900 is conducted by moving the upper mold part 82 downward. However, in practice, the lower mold part 81 may be designed such that the lower mold part 81 can be moved upward so that the magnetic powder 900 can be compressed upward and downward by the lower and upper mold parts 81, 82.

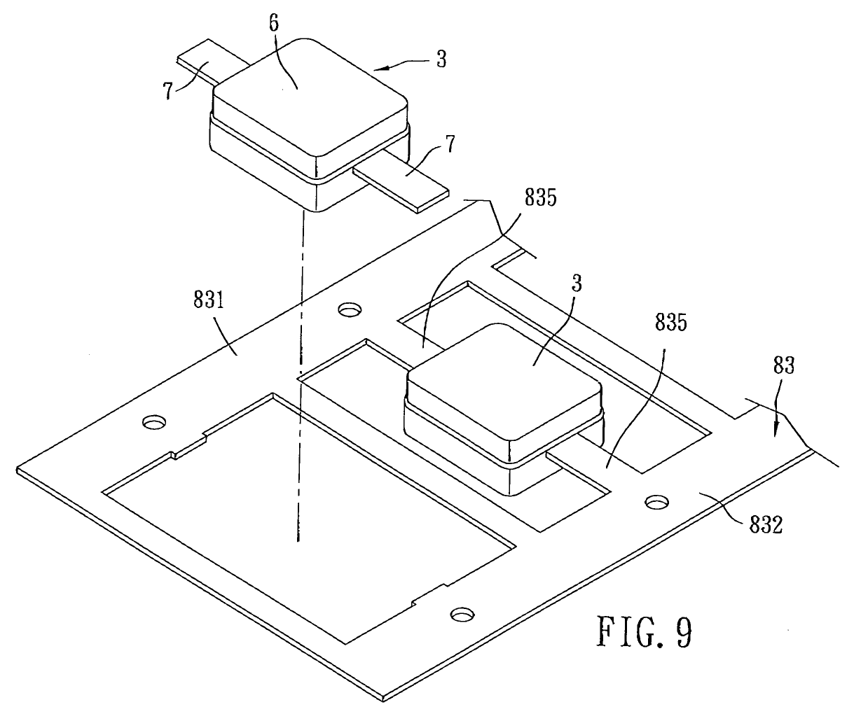

In step (f), after the upper mold part 82 and the pressing mold part 84 are removed from the lower mold part 81, each pair of the terminals 835 are cut off from the terminal frame 83 to form the two extension legs 7 of the inductor 3, as shown in FIG. 9.

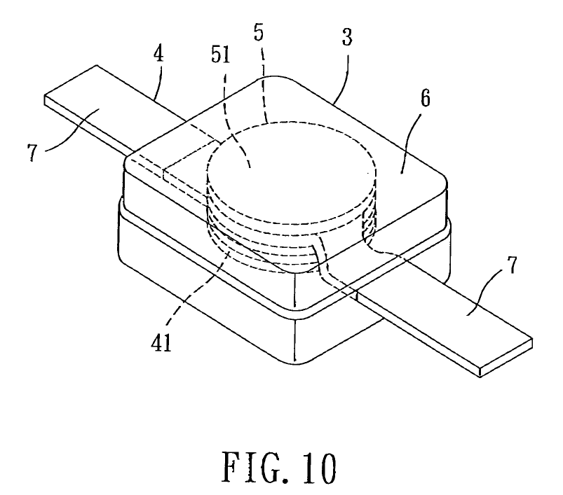

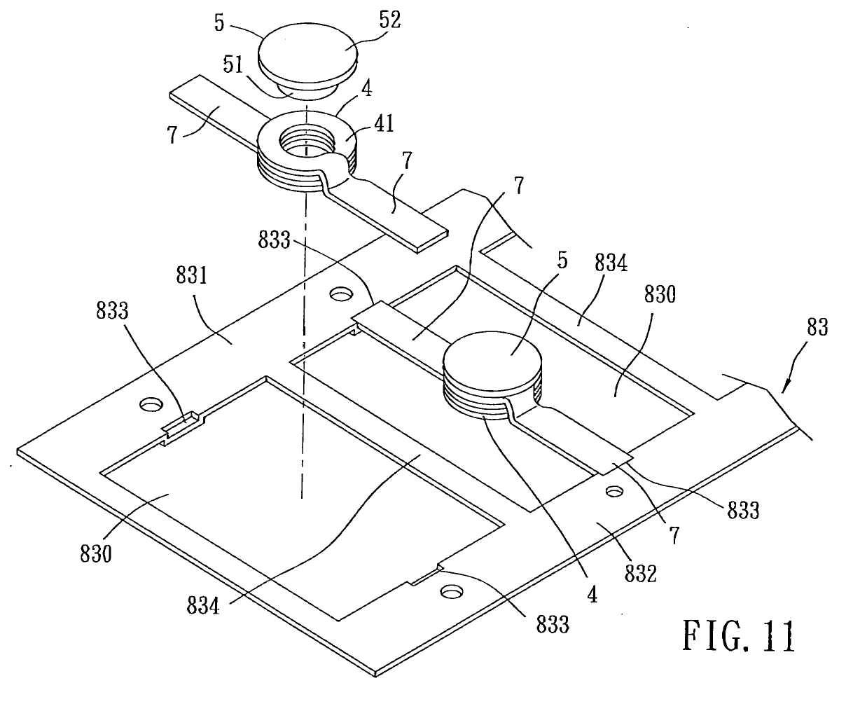

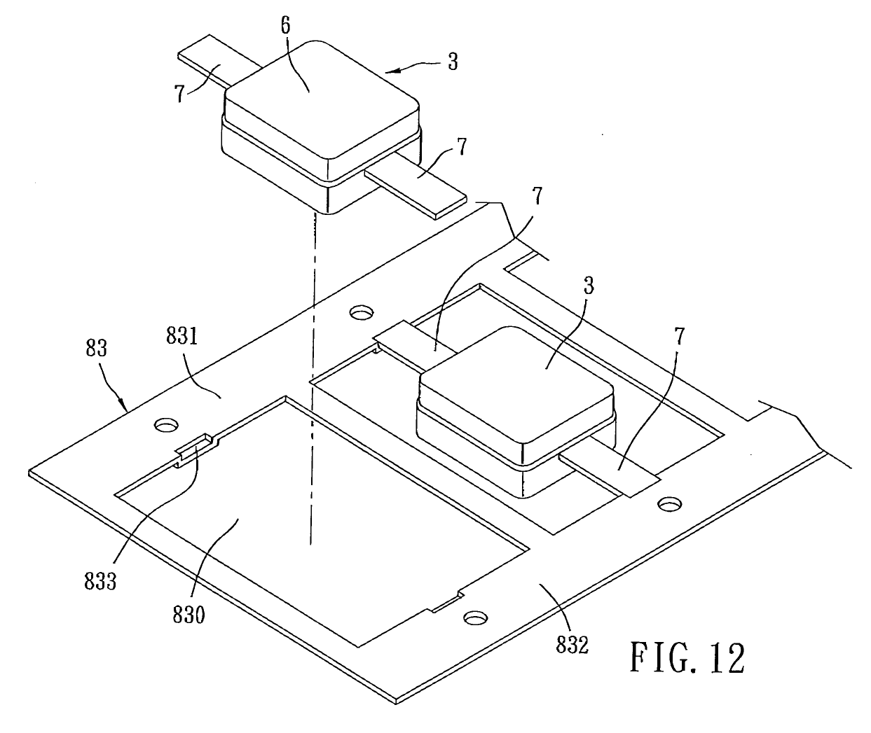

FIGS. 10 to 12 illustrate the third embodiment of the inductor 3 of this invention. The third embodiment differs from the second embodiment only in that the wire of each inductive coil 4 has a flat cross-section and that the two extension legs 7 of each inductive coil 4 are formed integrally with the coil portion 41.

Accordingly, when the inductors 3 of the third embodiment are manufactured, the terminal frame 83 is not provided with the terminals 835 shown in FIG. 6, but is provided with recesses 833 that are spaced apart along the first and second rails 831, 832. In manufacturing the inductors 3 of the third preferred embodiment, the extension legs 7 are detachably engaged in the respective recesses 833. Therefore, the step of cutting off the terminals 835 from the terminal frame 83 conducted in the second embodiment can be dispensed with in this embodiment. The method of manufacturing the inductors 3 of the third embodiment is simpler than that of the second embodiment.

In summary, by using the magnetic pillar 5 having the upper end formed with the radially projecting flange 52, the aforesaid drawback associated with the prior art can be eliminated. Therefore, higher production efficiency and yield rate can be achieved by the method for making the inductor 3 according to the present invention.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An inductor, comprising:
an inductive coil having a coil portion and two extension legs;
a magnetic pillar including a pillar portion that is inserted into said coil portion and that has an upper end projecting upwardly from said inductive coil, and a flange portion radially projecting from said upper end of said pillar portion, said flange portion pressing against an upper end of said coil portion; and
an embedding body in which said coil portion and said magnetic pillar are embedded, said extension legs being exposed from said embedding body.

2. The inductor of claim 1, wherein said extension legs project outwardly from an outer surface of said embedding body.

3. A method for making an inductor, comprising:
forming a magnetic pillar having an upper end formed with a radially projecting flange;
inserting the magnetic pillar into an inductive coil until the radially projecting flange presses against an upper end of the inductive coil;
disposing the inductive coil together with the magnetic pillar in a mold;
filling the mold with a magnetic powder; and
compression molding the magnetic powder to form an embedding body in which the inductive coil and the magnetic pillar are embedded.
